(19) United States
(12) Patent Application Publication
(10) Pub. No.: US 2010/0321157 A1
(43) Pub. Date: Dec. 23, 2010

(54) External media protection apparatus

(76) Inventor: De Sheng Chen, Yonghe City (TW)

Correspondence Address: Muncy, Geissler, Olds & Lowe, PLLC, 4000 Legato Road, Suite 310, FAIRFAX, VA, 22033, US

(21) Appl. No.: 11/826,696

(22) Filed: Jul. 17, 2007

(30) Foreign Application Priority Data
Jul. 19, 2006 (TW) 095212621

(51) Int. Cl. G06F 7/04

(52) U.S. Cl. 340/5.83

(57) ABSTRACT

The present invention relates to an external media protection apparatus, which comprises: a Printed Circuit Board (PCB) in which the following components are disposed thereon; a recognition unit, which is disposed on the PCB to receive and recognize finger print or other biology recognition data so as to generate a unique security code; and a first connection interface, which is disposed on the PCB and coupled to the recognition unit, such that it can couple to an internal or external storage device, then the unique security code is written into the internal or external storage device after it is optionally processed by an algorithm. In addition, the present invention further provides a cable connector.

### BACKGROUND OF THE INVENTION

1. Field of the Invention

The present invention relates to a media protection apparatus, and more particularly, to an external media protection apparatus that comprises a recognition unit. Wherein, the external media protection apparatus receives and recognizes finger print or other biology recognition data so as to generate a unique security code, and the security code is written into a storage device after it is optionally processed by an algorithm.

2. Description of the Related Art

The portable hard disk drive or storage device is coupled to a computer host through a connector so as to access the data stored in the host. However, if the data stored in the portable hard disk drive or storage device is not properly encrypted and decrypted, it can be easily stolen.

An encryption/decryption apparatus for the portable hard disk drive or storage device is presented on the current market. This encryption/decryption apparatus is serially connected between a host and the portable hard disk drive or storage device, such that the data transmitted between the host and the portable hard disk drive or storage device can be encrypted/decrypted and the data is secured.

However, the data transmitted between the host and the portable hard disk drive or storage device in the method mentioned above needs to be encrypted/decrypted. This process is complicated and costs more processing time and consumption power. Accordingly, the bandwidth for accessing the portable hard disk drive or storage device is deteriorated, which increases the cost waste and causes more inconvenience in carrying the device.

In addition, the aforementioned method does not provide the finger print or other biology recognition function, thus the ID of the user who accesses the portable hard disk drive, storage device or host cannot be effectively authenticated and managed. Additionally, since the access right is based on the “authenticated by object rather than by user” rule, the confidential data may be stolen if the encryption/decryption apparatus is lost.

Additionally, some connection interfaces have specific electric power and bandwidth limitation for its downstream ports.

Moreover, the storage device usually requires a large instant current and some connection interfaces require the wireless function.

Furthermore, a cable connector with 2-port structure is provided in the current market. However, among two ports, the extra one is only for providing additional electric power but not for dispersing bandwidth, which is not a good design.

### SUMMARY OF THE INVENTION

In order to resolve the aforementioned disadvantages of the conventional technique, it is an objective of the present invention to provide an external media protection apparatus comprising a recognition unit. Wherein, the media protection apparatus receives and recognizes a user's finger print or other biology recognition data so as to generate a unique security code, and the security code is written into a storage device after it is optionally processed by an algorithm. The storage device can be accessed only when the user's finger print or other biology recognition data is correct.

It is another objective of the present invention to provide an external media protection apparatus to protect the entire storage device. In addition, the data security of the file, folder, host access and other control functions are further ensured by the security code.

It is yet another objective of the present invention to provide an external media protection apparatus, which comprises a disposable or rechargeable battery in order to supply additional power and reinforce the insufficiency of the instant current.

It is yet another objective of the present invention to provide a multi-port cable connector that connects to a host and an external media protection apparatus simultaneously. Electric power in the host can be additionally supplied to the downstream external media protection apparatus and the connected storage device to through the multi-port of the cable connector, thus the external power adapter is not required. In addition, it is more important that the bandwidth can be properly dispersed among the finger print recognition unit, the encryption/decryption unit, and the portable hard disk drive or storage device, such that the system performance and flexibility are improved.

In order to achieve the aforementioned objectives, the present invention provides an external media protection apparatus, which comprises: a Printed Circuit Board (PCB) in which the following components are disposed thereon; a recognition unit disposed on the PCB to receive and recognize finger print or other biology recognition data so as to generate a unique security code; and a first connection interface, which is disposed on the PCB and coupled to the recognition unit, such that it can couple to an internal or external storage device, then the unique security code is written into the internal or external storage device after it is optionally processed by an algorithm.

In order to achieve the aforementioned objectives, the present invention provides a cable connector, which comprises: a first connector for coupling to an external device; a first cable having one end coupled to the first connector; a second connector coupled to another end of the first cable for coupling to a host; and a second cable having one end coupled to the second connector; and a third connector coupled to another end of the second cable for coupling into an internal storage device or another storage device in the host. In addition, all cables and connectors mentioned above may be wirelessly connected.

### BRIEF DESCRIPTION OF THE DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a schematic block diagram of an external media protection apparatus according to a preferred embodiment of the present invention.

FIG. 2 is a schematic diagram showing a case included in the external media protection apparatus according to the present invention.

FIG. 3(a)˜3(c) are the schematic diagrams of the cable connectors according to another embodiment of the present invention.

FIG. 4 is a schematic diagram showing an adapter included in the cable connector according to the present invention.

### DETAILED DESCRIPTION OF THE PREFERRED EMBODIMENTS

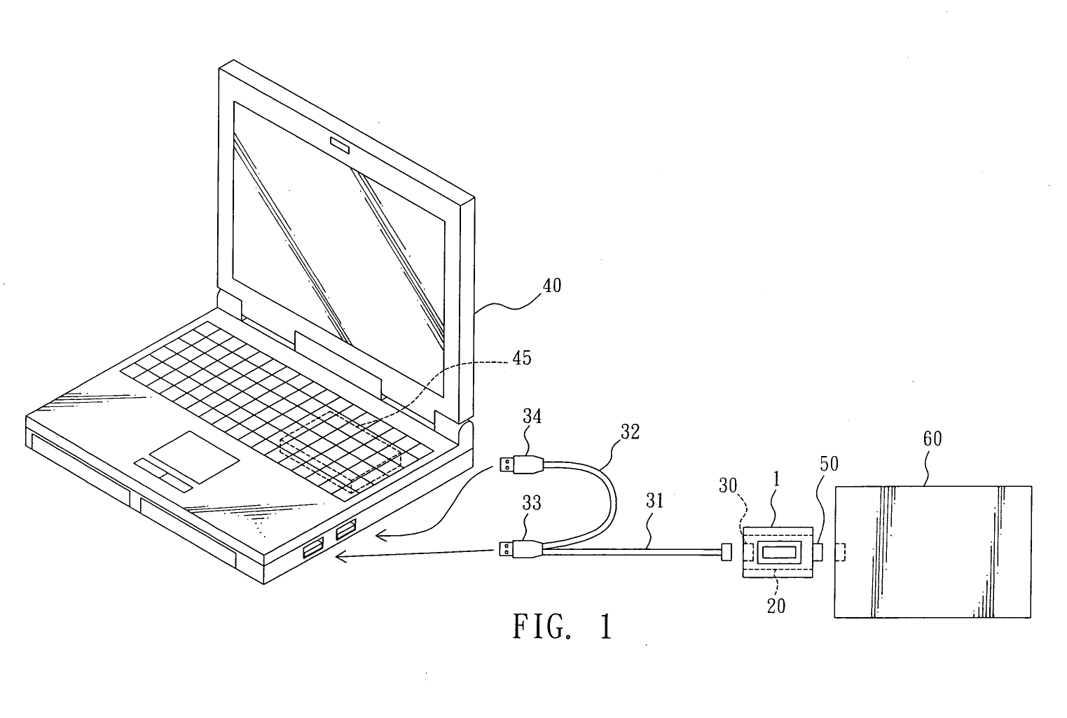

Referring to FIG. 1, which schematically shows a block diagram of an external media protection apparatus 1 according to a preferred embodiment of the present invention. As shown in the drawing, the external media protection apparatus 1 of the present invention comprises: a PCB 10; a recognition unit 20; a first connection interface 30; and a second connection interface 50.

Wherein, the PCB 10 is used to dispose the recognition unit 20 and the first connection interface 30, . . . etc.

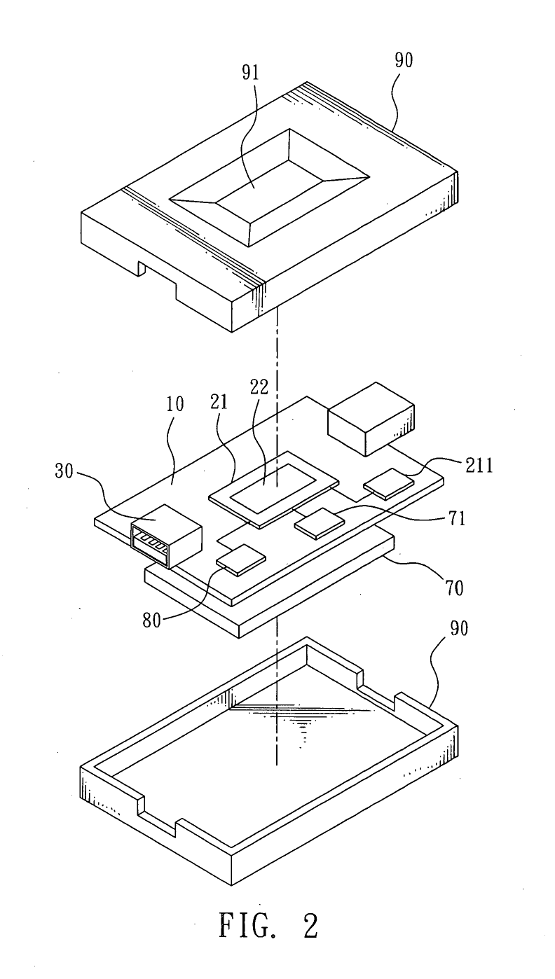

Referring to FIG. 2, the recognition unit 20 includes but is not limited to be a finger print or any other biology data recognition unit. The recognition unit 20 is disposed on the PCB 10 to receive and recognize a user's finger print or other biology recognition data in order to generate a unique security code. In the present embodiment, the recognition unit 20 is a finger print recognition unit, but it is not limited to be the finger print recognition unit. The recognition unit 20 further comprises a microcontroller 21 and a finger print recognition chip 22. Wherein, the finger print recognition chip 22 receives the finger print data, and the microprocessor 21 couples to the finger print recognition chip 22 and comprises a memory 211. The memory 211 includes but is not limited to be a Flash memory or a Read Only Memory (ROM). The microcontroller 21 receives and recognizes the finger print data so as to generate the unique security code. Wherein, the microprocessor 21 further comprises a control program (not shown) which is stored in the memory 211 for controlling the operation of the microcontroller 21.

The first connection interface 30 is a composite interface, which is disposed on the PCB 10 and coupled to the finger print recognition unit 20, such that it can couple to a first storage device 45, then the unique security code is written into the first storage device 45 after it is optionally processed by an algorithm. Wherein, the first connection interface 30 includes but is not limited to be a USB interface, an OTG/HOST USB interface, an IDE interface, a SATA interface, a SAS interface, a CE-ATA interface, an IEEE 1394 interface, a LAN interface, a Wireless LAN interface, a Wireless USB interface, a Wireless IEEE 1394 interface or other interfaces. In the present embodiment, the USB interface is exemplified for explanation, but it is not limited to be the USB interface.

The first storage device 45 coupled to a host 40 includes but is not limited to be a HDD (Hard Disk Drive) device, an optical storage device, a Flash memory, a Flash memory card, a card reader or other devices. The host 40 includes but is not limited to be a server, a desktop computer, a notebook computer, a MP3 player, a cellular phone, an electrical home appliance, a tablet pen, a portable multimedia player, a Personal Digital Assistant (PDA), a GPS receiver, a digital audio/video broadcast unit or other devices. In the present embodiment, the HDD device disposed in the host 40 is exemplified for explanation, but it is not limited to be the HDD device.

In addition, the external media protection apparatus 1 of the present invention further comprises a second connection interface 50, which is disposed opposite to the first connection interface 30 on the PCB 10. The external media protection apparatus 1 couples to the finger print recognition unit 20 or directly couples to the first connection interface 30 to receive the unique security code, and the unique security code is transmitted to a second storage device 60 after it is optionally processed by an algorithm. Wherein, the second connection interface 50 includes but is not limited to be a USB interface, an OTG/HOST USB interface, an IDE interface, a SATA interface, a SAS interface, a CE-ATA interface, an IEEE 1394 interface, a LAN interface, a Wireless LAN interface, a Wireless USB interface, a Wireless IEEE 1394 interface or other interfaces. In the present embodiment, the USB interface is exemplified for explanation, but it is not limited to be the USB interface.

The second storage device 60 includes but is not limited to be a HDD device, an optical storage device, a Flash memory, a Flash memory card, a card reader, a MP3 player, a cellular phone, an electrical home appliance, a tablet pen, a portable multimedia player, a Personal Digital Assistant (PDA), a GPS receiver, a digital audio/video broadcast unit, a digital camera/digital camcorder or other devices. The HDD device complying with the IDE-ATA3 specification (including ATA3 and its successors) is exemplified in the present embodiment for explanation, but it is not limited to it. The ATA3 HDD includes a security code mechanism and the ATA3 HDD is activated only when the security code is correct, which secures the internal data.

In addition, the first connection interface 30 of the present invention further comprises a first cable 31 and a second cable 32. Wherein, the first cable 31 is a composite cable, in which one end of the first cable 31 couples to the first connection interface 30, and another end of the first cable 31 has a first connector 33. One end of the second cable 32 couples to a second connector 34, and the host 40 is connected through the first cable 31. The first connector 33 is directly or indirectly coupled to the second storage device 60, and the second connector 34 is connected to the finger print recognition unit 20 and the first storage device 45, so as to disperse its bandwidth and improve the operating speed. Additionally, one end of the first cable 31 in the present invention may be directed welded onto the first connection interface 30 to save the connection device in the first connection interface 30. Furthermore, in order to reduce the space occupied by the cables 31 and 32, the cables 31, 32 and the connectors 33, 34 may be implemented wirelessly.

In addition, the external media protection apparatus 1 of the present invention further comprises a chargeable battery or super capacitor 70 and a charging circuit 71, which are all disposed on the PCB 10. Wherein, the charging circuit 71 charges the chargeable battery or super capacitor 70 by obtaining electric power from the host 40 or an external power adapter (not shown). The chargeable battery or super capacitor 70 does not only supply electric power to the external media protection apparatus 1 and the second storage device 60, but also supplements the insufficient power caused by the instant current. Wherein, the chargeable battery or super capacitor 70 and the charging circuit 71 may be replaced with the general non-chargeable disposable battery, which includes but is not limited to be a fuel battery.

In addition, the external media protection apparatus 1 of the present invention further comprises a token generator 80, which may be internally or externally disposed and coupled to the microprocessor 21, such that a token can be generated and provided to the first storage device 45 or the second storage device 60. Accordingly, the external media protection apparatus 1 of the present invention compares not just the security code, but also the token, such that the external media protection apparatus 1 of the present invention can be applied on any type of storage media while still maintaining its flexibility.

As the descriptions mentioned above, the recognition unit 20 of the present invention is integrated with the microprocessor 21, which includes but is not limited to be a dual-engine microprocessor to encrypt/decrypt the data transmitted between the host 40 and the portable hard disk drive or storage device 60. Accordingly, the recognition unit 20 of the present invention does not only recognize the finger print, but also encrypt/decrypt data by using different ports, such that the bandwidth is dispersed.

As described above, when the external media protection apparatus 1 of the present invention is utilized, the first connection interface 30 is respectively coupled to the USB port of the host 40 and the first storage device 45 through the first cable 31 and the second cable 32. The second connection interface 50 is connected to the second storage device 60. After the user places his/her finger (e.g. a forefinger) on the finger print recognition chip 22, the finger print recognition chip 22 recognizes and transmits the finger print data to the microprocessor 21, and a unique security code is written into the second storage device 60 through the second connection interface 50 after it is optionally processed by an algorithm. Afterwards, the security code is checked and compared by the second storage device 60. If it matches, the user is allowed to access the second storage device 60. Otherwise, the second storage device 60 is not activated. Therefore, the data stored in the second storage device 60 is secured and it is not required to encrypt/decrypt each record of data, which simplifies processing steps and saves time. Accordingly, the external media protection apparatus 1 of the present invention indeed improves the disadvantages of the conventional encryption/decryption apparatus.

FIG. 2 is a schematic diagram showing a case included in the external media protection apparatus according to the present invention. As shown in the drawing, the external media protection apparatus of the present invention further comprises a case 90, which is preferably made of plastic or metal material to accommodate the PCB 10 and protect the components disposed thereon. In addition, a window 91 is further disposed on the case 90 to expose the finger print recognition chip 22. Additionally, the case 90 may be disposed alone or may be integrated with the case of the second storage device 60 into a single piece, since it is the known technique in the prior art, its detail is intentionally omitted herein.

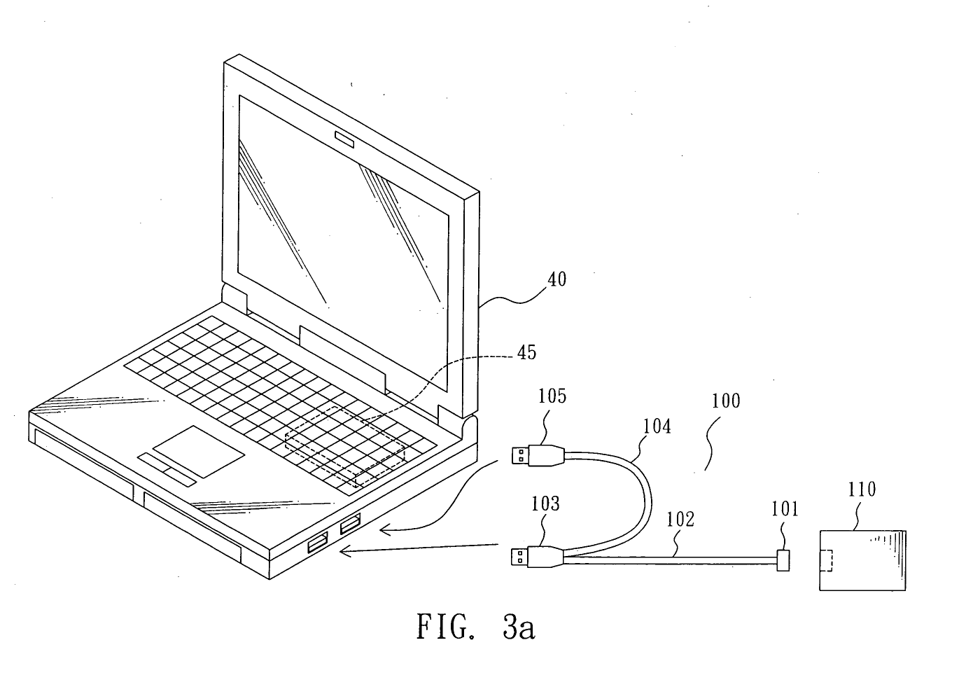

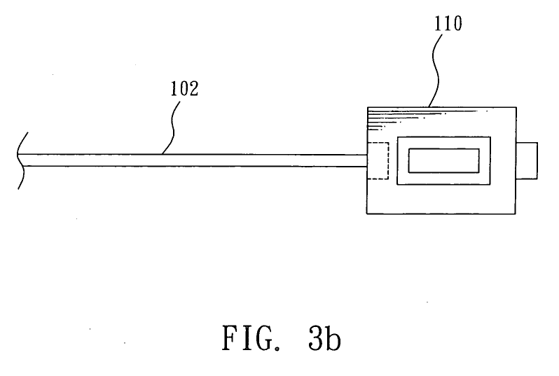

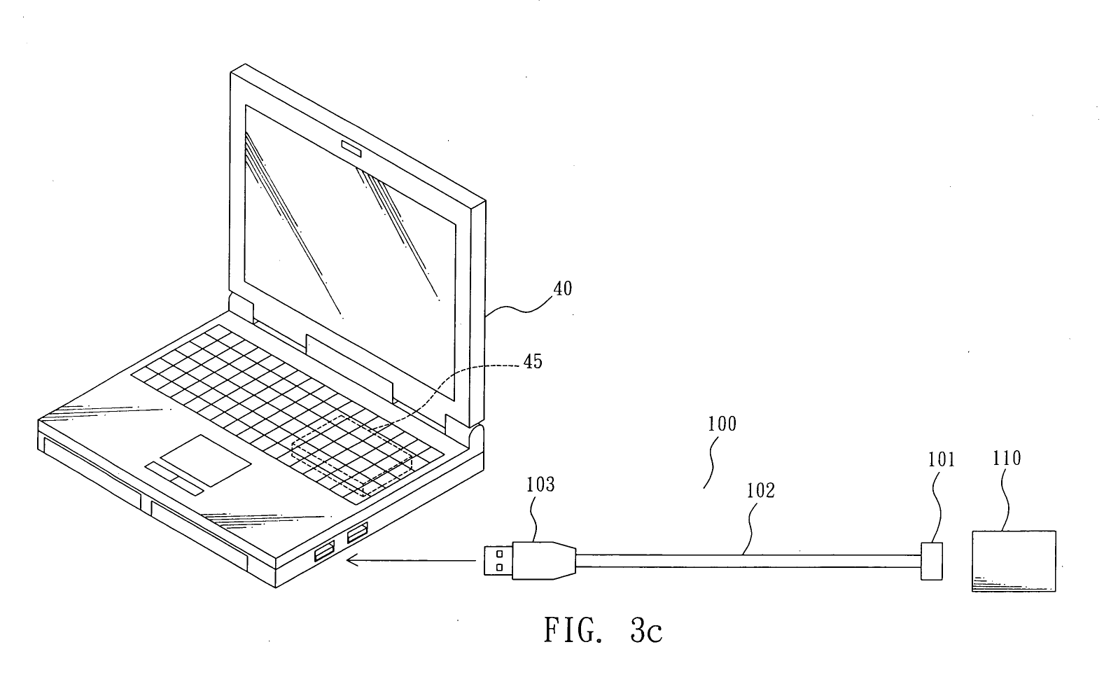

Referring to FIG. 3(a)˜3(c), which schematically show the cable connectors according to another embodiment of the present invention. As shown in FIG. 3(a), the cable connector 100 of the present invention comprises: a first connector 101 for coupling to an external device 110; a first cable 102 having one end coupled to the first connector 101; a second connector 103 coupled to another end of the first cable 102 for coupling to the host 40; a second cable 104 having one end coupled to the second connector 103; and a third connector 105 coupled to another end of the second cable 104 for coupling to a first storage device 45 in the host 40 or a plurality of other storage devices. Wherein, the cables 102, 104 and the connectors 101, 103, 105 may be implemented wirelessly.

Wherein, the first connector 101, the second connector 103, and the third connector 105 include but are not limited to be a USB interface, an OTG/HOST USB interface, an IDE interface, a SATA interface, a SAS interface, a CE-ATA interface, an IEEE 1394 interface, a LAN interface, a Wireless LAN interface, a Wireless USB interface, a Wireless IEEE 1394 interface or other interfaces. Wherein, the first connector 101 is a composite connector.

The first storage device 45 coupled to the host 40 includes but is not limited to be a HDD (Hard Disk Drive) device, an optical storage device, a Flash memory, a Flash memory card, a card reader or other devices.

The external device 110 is an external media protection apparatus, such that it can couple to a second storage device 60, which includes but is not limited to be a HDD device, an optical storage device, a Flash memory, a Flash memory card, a card reader, a MP3 player, a cellular phone, a tablet pen, a portable multimedia player, a Personal Digital Assistant (PDA), a GPS receiver, a digital audio/video broadcast unit, a digital camera/digital camcorder or other devices.

As shown in FIG. 3(b), in the cable connector 100 of the present invention, one end of the first cable 102 may be directly welded onto the connection interface (not shown) of the external device 110, so as to save the connection device in the connection interface.

As shown in FIG. 3(c), the cable connector 100 of the present invention may only comprise the first cable 102, and two ends of the first cable 102 respectively comprise the first connector 101 and the second connector 103, so as to save the second cable 104 and the third connector 105. By using the cable connector 100 with such configuration, the external device 110 may couple to a bus switch or a hub (not shown), such that the external device 110 and the second storage device 60 can share the bandwidth.

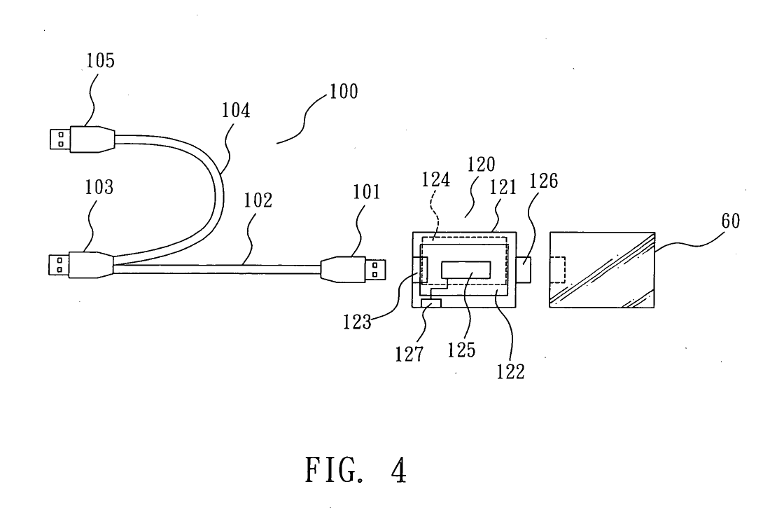

Referring to FIG. 4, which schematically shows an adapter included in the cable connector according to the present invention. As shown in the drawing, the cable connector 100 of the present invention further comprises an adapter 120, and the adapter 120 has a case 121 and a PCB 122. In addition, the PCB 122 further comprises: a fourth connector 123, a chargeable battery or a super capacitor 124, disposable battery, a charging circuit 125, and a fifth connector 126.

Wherein, the fourth connector 123 is disposed on the PCB 122, such that it can couple to the first connector 101. The charging circuit 125 couples to the fourth connector 123 so as to obtain electric power through the fourth connector 123. The charging circuit 125 couples to the chargeable battery or super capacitor 124 in order to charge the chargeable battery or super capacitor 124. The fifth connector 126 couples to the second storage device 60 or the external media protection device 110, such that it can provide electric power to the second storage device 60 or the external media protection device 110. Wherein, the fourth connector 123 and the fifth connector 126 may be a USB interface, an OTG/HOST USB interface, an IDE interface, a SATA interface, a SAS interface, a CE-ATA interface, an IEEE 1394 interface, a LAN interface, a Wireless LAN interface, a Wireless USB interface, a Wireless IEEE 1394 interface or other connectors. Alternatively, the fourth connector 123 and the fifth connector 126 may be implemented wirelessly. Additionally, one end of the first cable 102 of the cable connector 100 in the present invention may be directed welded onto the fourth connector 123 in the adapter 120 so as to save the connection device in the connection interface.

In addition, the PCB 122 further comprises a socket 127, which is disposed on the PCB 122 and coupled to the charging circuit 125. The socket 127 is coupled to an AC power source through an external power adapter to provide electric power and charge the chargeable battery or super capacitor 124.

In summary, the external media protection apparatus of the present invention comprises a finger print recognition unit. After the finger print recognition unit receives and recognizes finger print data, a unique security code is generated. Then, the security code is written into a storage device after it is optionally processed by an algorithm. If the user's finger print is correct, the storage device can be accessed by the user. Otherwise, the storage device is not activated. In addition, a token generator is further comprised in the present invention to make good use of the finger print data, such that it can effectively improve the disadvantages of the conventional encryption/decryption apparatus.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. An external media protection apparatus, comprising:
a Printed Circuit Board (PCB), in which the following components are disposed thereon;
a recognition unit, disposed on said PCB to receive and recognize finger print or other biology recognition data so as to generate a unique security code; and
a first connection interface, disposed on said PCB and coupled to said recognition unit for coupling to a first storage device, wherein said unique security code is written into said first storage device after optionally processed by an algorithm.

2. The external media protection apparatus of claim 1, wherein said recognition unit is a finger print or any other biology data recognition unit, which further comprises: a microprocessor, a recognition chip, a control program, and a token generator, wherein said recognition chip receives and recognizes said finger print or other biology recognition data; said microprocessor couples to said recognition chip and a memory, here said memory is a Flash memory or Read Only Memory (ROM) for receiving said finger print or other biology recognition data so as to generate said unique security code; said control program is stored in said memory and used to control said microprocessor's operation; said token generator couples to said microprocessor to generate and provide a token to said first and said second storage device, and said token generator may cooperate with said security code of said finger print or other biology recognition data.

3. The external media protection apparatus of claim 1, wherein said first connection interface is a USB interface, an OTG/HOST USB interface, an IDE interface, a SATA interface, a SAS interface, a CE-ATA interface, an IEEE 1394 interface, a LAN interface, a Wireless LAN interface, a Wireless USB interface, a Wireless IEEE 1394 interface or other interfaces, and said first connector may be a composite connector or implemented wirelessly.

4. The external media protection apparatus of claim 1, wherein said first storage device coupled to a host is a HDD device, an optical storage device, a Flash memory, a Flash memory card, a card reader, a MP3 player, a cellular phone, a tablet pen, a portable multimedia player, a Personal Digital Assistant (PDA), a GPS receiver, a digital audio/video broadcast unit, a digital camera/digital camcorder or other devices.

5. The external media protection apparatus of claim 4, further comprising a second connection interface, wherein said second connection interface is disposed opposite to said first connection interface on said PCB and couples to said finger print recognition unit or directly couples to said first connection interface in order to receive and transmit said unique security code to a second storage device, said second connection interface does not only protect the entire storage device, but also protects the data security of a file, folder, or downstream I/O device and secures other management functions; wherein said second connection interface is a USB interface, an OTG/HOST USB interface, an IDE interface, a SATA interface, a SAS interface, a CE-ATA interface, an IEEE 1394 interface, a LAN interface, a Wireless LAN interface, a Wireless USB interface, a Wireless IEEE 1394 interface or other interfaces, and said second connection interface may be implemented wirelessly; additionally, said second storage device is a HDD device, an optical storage device, a Flash memory, a Flash memory card, a card reader, a MP3 player, a cellular phone, a tablet pen, a portable multimedia player, a Personal Digital Assistant (PDA), a GPS receiver, a digital audio/video broadcast unit, a digital camera/digital camcorder or other devices.

6. The external media protection apparatus of claim 1, wherein said first connection interface further comprises a first cable and a second cable, one end of said first cable couples to said first connection interface, another end of said first cable has a first connector, and one end of said second cable couples to a second connector; wherein said second connector can couple to said finger print recognition unit, and said first connector can couple to said second storage device, so as to disperse the bandwidth, improve the operating speed, and to supply electric power to said external media protection apparatus and said second storage device.

7. The external media protection apparatus of claim 2, further comprising a case, wherein said case has a window to expose said recognition chip, and said case may be disposed alone or integrated into a single piece with a case of said second storage device.

8. The external media protection apparatus of claim 7, further comprising a chargeable battery, a super capacitor or disposable battery, a charging circuit, and an encryption/decryption chip, which being all disposed on said PCB, wherein said charging circuit is used to charge said chargeable battery or said super capacitor, such that electric power is supplied to said second storage device and said external media protection apparatus, and said encryption/decryption chip is coupled to said microprocessor in order to encrypt/decrypt and output data.

9. A cable connector, comprising:
a first connector, being a composite connector for coupling to an external device;
a first cable having one end coupled to said first connector;
a second connector coupled to another end of said first cable for coupling to a host;
a second cable having one end coupled to said second connector; and
a third connector coupled to another end of said second cable for coupling to a first storage device in said host.

10. The cable connector of claim 9, wherein said first connector, said second connector, and said third connector is a USB interface, an OTG/HOST USB interface, an IDE interface, a SATA interface, a SAS interface, a CE-ATA interface, an IEEE 1394 interface, a LAN interface, a Wireless LAN interface, a Wireless USB interface, a Wireless IEEE 1394 interface or other interfaces, and said first connector, said second connector, and said third connector may be implemented wirelessly.

11. The cable connector of claim 9, wherein said first storage device coupled to a host is a HDD device, an optical storage device, a Flash memory, a Flash memory card, a card reader, a MP3 player, a cellular phone, a tablet pen, a portable multimedia player, a Personal Digital Assistant (PDA), a GPS receiver, a digital audio/video broadcast unit, a digital camera/digital camcorder or other devices; said external device is an external media protection apparatus that can couple to a second storage device, and said second storage device is a HDD device, an optical storage device, a Flash memory, a Flash memory card, a card reader, a MP3 player, a cellular phone, a tablet pen, a portable multimedia player, a Personal Digital Assistant (PDA), a GPS receiver, a digital audio/video broadcast unit, a digital camera/digital camcorder or other devices.

12. The cable connector of claim 9, further comprising an adapter, wherein said adapter comprises a case and a PCB, and said PCB further comprises: a fourth connector, a chargeable battery, a super capacitor or disposable battery, a charging circuit, and a fifth connector; wherein said fourth connector is disposed on said PCB and coupling to said first connector; said charging circuit couples to said fourth connector so as to obtain electric power through said fourth connector; said charging circuit couples to said chargeable battery or super capacitor in order to charge said chargeable battery or super capacitor; and said fifth connector couples to said second storage device or said external media protection apparatus so as to supply electric power to said second storage device or said external media protection apparatus; furthermore, said fourth connector and said fifth connector may be implemented wirelessly.

13. The cable connector of claim 12, further comprising a socket, wherein said socket is disposed on said PCB and coupled to said charging circuit, such that said socket can connect to an AC power source through an external power adapter in order to supply electric power and charge said chargeable battery or super capacitor.
